(19) United States
(12) Patent Application Publication
(10) Pub. No.: US 2009/0157212 A1
(43) Pub. Date: Jun. 18, 2009

(54) SYSTEM AND METHOD OF DETERMINING PAINT FORMULA HAVING A EFFECT PIGMENT

(75) Inventors: CRAIG J. McCLANAHAN, BOWLING GREEN, OH (US); JIM P. SOSS, TOLEDO, OH (US); SCOTT A. HARTFORD, SWANTON, MI (US)

Correspondence Address: HOWARD & HOWARD ATTORNEYS PLLC;BASF CORPORATION, 450 West Fourth Street, Royal Oak, MI, 48067, US

(73) Assignee: BASF CORPORATION, FLORHAM PARK, NJ (US)

(21) Appl. No.: 11/954,281

(22) Filed: Dec. 12, 2007

(51) Int. Cl. G06F 19/00

(52) U.S. Cl. 700/107

(57) ABSTRACT

A system and method of determining a paint formula having an effect pigment is provided. The system includes a coarseness gauge which may be placed adjacent to a painted surface, such as that of a vehicle. A technician compares the gauge to the painted surface to determine a coarseness of the effect pigment. This coarseness is then used to select and/or adjust a paint formula such that an accurate match may be achieved.

### BACKGROUND OF THE INVENTION

1. Field of the Invention

The subject invention relates to a method and system for determining a paint formula to match a paint having an effect pigment and coating a surface of an object.

2. Description of the Related Art

The use of effect pigments, such as mica or metallic flakes in paint is well known to those skilled in the art. The resulting paint provides dramatic effects that are often used to accentuate the shape of a painted object. Such effect pigments are often used in paint for vehicles; however, usage has spread to numerous other industries as well.

These effect pigments typically change the color of the paint. In fact, the angle at which the painted object is viewed is also a factor in the color. Of course, numerous other factors will affect the color and appearance of the paint, including size/coarseness of the effect pigments, the type of material of the effect pigments, the purity/consistency of the effect pigment, and the concentration of the effect pigment. Furthermore, variations in these factors may occur over the long-term at manufacturing facilities. As a consequence, multiple vehicles produced on a common assembly line may have noticeably different colors or appearances.

The use of these effect pigments sets forth a difficult challenge for vehicle refinishing, i.e., “bump shop”, operations. Specifically, it is difficult to accurately match the color when painting a replacement component for the vehicle. Said another way, it is difficult to determine a paint formula or “recipe” that will accurately reflect the paint on any given vehicle. Often, trial-and-error iterations are utilized to determine the paint formula. These iterations are time consuming and involve mixing a small amount of paint, painting a small portion of the vehicle or a test panel, waiting for the paint to dry, and comparing the new paint to the existing paint of the vehicle.

Numerous prior art references attempt to solve these difficulties. For example, PCT Publication No. WO 2006/030028 (the '028 publication) discloses a method of determining a paint formula. The method of the '028 publication involves acquiring a digital image of the paint to resolve the size/coarseness of the effect pigment. Unfortunately, such precision photographic equipment tends to be quite expensive and is subject to breakage and abuse in a typical collision center environment. Therefore, there remains a need for a method of determining a paint formula that is not necessitated on expensive photographic equipment to determine size/coarseness of the effect pigments.

### SUMMARY OF THE INVENTION AND ADVANTAGES

The subject invention provides methods of determining a paint formula to match a paint coating a surface of an object, where the paint includes an effect pigment and the method utilizes a computerized system. The methods include the step of providing a coarseness gauge exhibiting differing levels of coarseness of the effect pigment. The coarseness gauge is disposed adjacent to the coated surface of the object and a comparison of the coarseness gauge and the effect pigment of the paint is performed to determine a coarseness of the effect pigment of the paint. The coarseness gauge of the effect pigment of the paint is then used to select a paint formula from a list of paint formulas determined with a spectrophotometer and/or discard at least one paint formula from a list of paint formulas from a database.

The subject invention also provides a computerized system for determining a paint formula to match paint having an effect pigment and coating a surface of an object. The system includes a spectrophotometer for measuring a color of the paint coating the object and producing color information. A coarseness gauge exhibiting differing levels of coarseness of the effect pigment is movable adjacent to the surface of the object. The system also includes a computer for receiving the color information and the coarseness, determining a paint formula based on the color information, and modifying the paint formula to adjust the paint formula of the paint based on the coarseness of the effect pigment.

The system and methods of the subject invention provide numerous advantages over the prior art. Particularly, the utilization of the coarseness gauge allows for an inexpensive, yet accurate estimation of the coarseness of the effect pigment of the paint. Furthermore, use of this coarseness gauge is easy for collision center technicians to master without complicated training. But most importantly, the system and methods provide the technician with a reliable paint formula that may be immediately mixed and used without time consuming trial-and-error iterations.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a flowchart showing a first embodiment of a method of the subject invention;

FIG. 2 is a conceptualized view of a computerized system for determining and/or adjusting a paint formula;

FIG. 3 is a top view of a coarseness gauge showing various levels of coarseness of an effect pigment;

FIG. 4 is a cross-sectional view of the coarseness gauge disposed on an object being analyzed at a first viewing angle;

FIG. 5 is a cross-sectional view of the coarseness gauge disposed on the object being analyzed at a second viewing angle; and

FIG. 6 is a flowchart showing a second embodiment of the method of the subject invention.

### DETAILED DESCRIPTION OF THE INVENTION

Referring to the Figures, wherein like numerals indicate corresponding parts throughout the several views, the present invention provides methods 100, 200 and a computerized system 10 for determining and/or adjusting a paint formula.

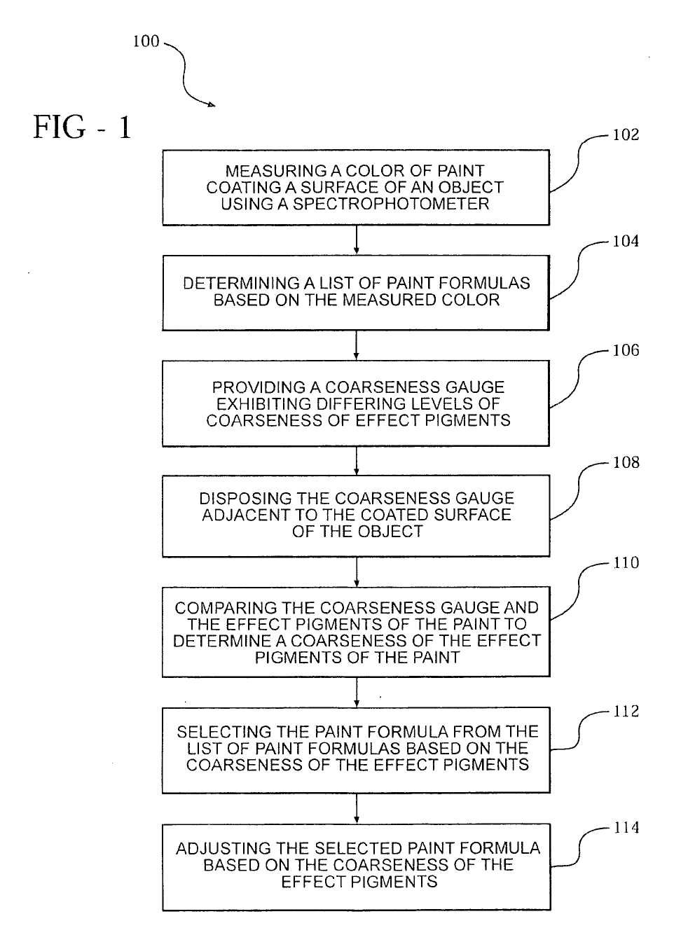

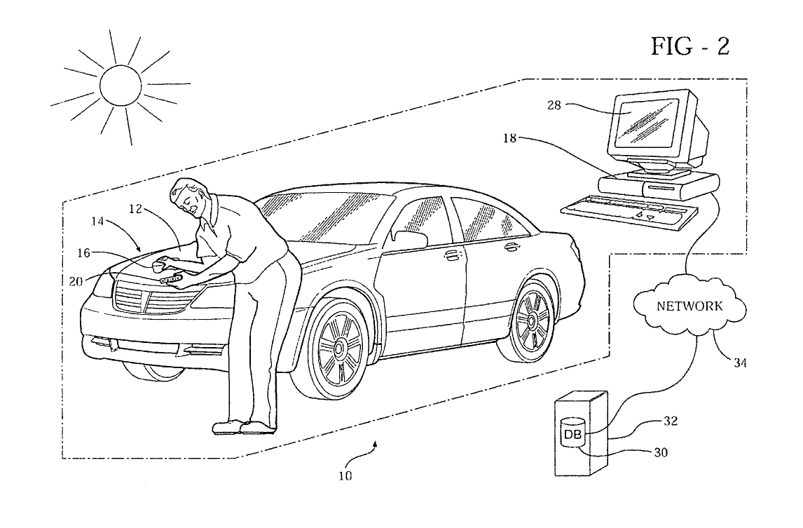

Referring to FIGS. 1 and 2, a first embodiment of the present invention provides the method 100 for adjusting a paint formula to match a paint coating a surface 12 of an object 14 utilizing the computerized system 10. The paint formula includes an effect pigment. Effect pigments are commonly used in paints to provide the paint with texture, sparkle, or other visual attributes. Numerous metallic and dielectric materials are used as effect pigments. For example, aluminum and mica flakes are very commonly used. Of course, those skilled in the art realize other materials for use as effect pigments. The object 14 is preferably a vehicle, such as an automobile (as shown in FIG. 2), motorcycle, or boat. However, those skilled in the art realize that numerous other objects may also be coated by paint.

The method 100 of the first embodiment includes the step 102 of measuring a color of the paint coating a surface 12 of the object 14 using a spectrophotometer 16. Spectrophotometers 16 are well known to those skilled in the art for determining the color of paint. Specifically, the spectrophotometer 16 detects the wavelength of reflected light to determine the color of the paint. The spectrophotometer 16 produces color information relating to the color of the paint. This color information may be presented as L*a*b* data, which is well known to those skilled in the art. Those skilled in the art will realize other suitable techniques for conveying the color information.

The method 100 also includes the step 104 of determining at least one paint formula based on the measured color. Said another way, once the spectrophotometer 16 provides the color of the paint, at least one recipe for making a matching paint is ascertained. This step is preferably performed by a computer 18. The computer 18 receives the color information and, in response, determines a list of paint formulas based on the color information. Obviously, the list of paint formulas could contain only a single paint formula. Each of the paint formulas preferably provide a ratio of base resin to at least one tinting pigment. Alternatively, the spectrophotometer 16 could provide the paint formulas without use of the computer 18. Determination of the paint formulas may be accomplished using several techniques. In one technique, an algorithm utilizes the color information to compute the amount of a dye pigment. In another technique, a database stores a plurality of records with each record correlating color information to a paint formula. However, regardless of the technique used, a paint mixed according to this formula may not match the color of the paint coating the object 14 due to the effect pigment in the paint.

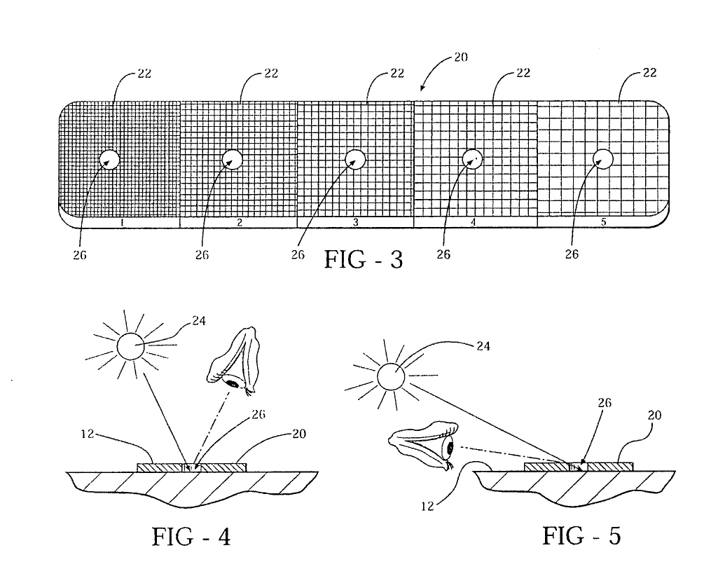

Referring to FIG. 3, the subject invention utilizes a coarseness gauge 20 to measure the coarseness of the effect pigment used in the object. The coarseness gauge 20 exhibits differing levels of coarseness of effect pigments. As such, the method 100 includes the step 106 of providing a coarseness gauge 20 exhibiting differing levels of coarseness of effect pigments. The coarseness of the effect pigment refers to the apparent size of the particles of the effect pigment. For example, an effect pigment having relatively large sized particles would be considered coarser than an effect pigment having relatively small sized particles.

The coarseness gauge 20 is preferably formed of paper, plastic, or other lightweight, suitable material. The coarseness gauge 20 must be sized such that it is easily portable. The coarseness gauge 20 is preferably thin with a rectangular, strip-like shape. Of course, other shapes for the coarseness gauge 20 may be contemplated by those skilled in the art, including, but not limited to, a circular shape.

Preferably, the coarseness gauge 20 is divided into a plurality of discrete sections 22. More preferably, the coarsness gauge is divided into five discrete sections. The use of five discrete sections provides enough coarseness variations to properly estimate the various effect pigment used in paints, while still allowing a user to discern differences between each discrete section. Each discrete section 22 of the coarseness gauge is categorized and labeled with a coarseness value. Preferably, the coarseness value is one of the integers 1, 2, 3, 4, or 5, with 1 being the finest effect pigment and 5 being the coarsest effect pigment. Of course, those skilled in the art realize other ways to categorize and label each discrete section 22 of the coarseness gauge 20.

The method 100 preferably includes the step 108 of disposing the coarseness gauge adjacent to the coated surface of the object. More preferably, the coarseness gauge is placed in contact with the coated surface, such that the coarseness gauge and the painted surface may be viewed simultaneously or near simultaneously.

The method 100 also includes the step 110 of comparing the coarseness gauge and the effect pigment of the paint to determine a coarseness of the effect pigment of the paint. This step 110 is accomplished by viewing the paint having the effect pigment and the various sections of the coarseness gauge 20 and ascertaining which of the sections 22 has a coarseness that most correctly matches the coarseness of the effect pigment in the paint of the object. Preferably, to ascertain the most correct viewing of the paint and coarseness gauge, the viewing should be done under a suitable light source 24, including, but not limited to, direct sunlight or a bright artificial light.

The apparent coarseness of the effect pigment in the paint may look different depending on the angle at which it is viewed. Therefore, to obtain the most accurate measurement of the coarseness of the effect pigment in the paint, it is preferred that the viewing of the coarseness gauge 20 and the paint should be performed at more than one angle. Specifically, it is preferred that the coarseness gauge 20 and paint should be viewed at a pair of angles that are 30 degrees different from each other. Said another way, the step of comparing the coarseness gauge and the effect pigment of the paint can be broken up into two steps. The first step is viewing the coarseness gauge 20 and the paint at a first angle with respect to the surface, as shown in FIG. 4, to determine a first angle coarseness of the effect pigment. The second step is viewing the coarseness gauge 20 and the paint at a second angle with respect to the surface, as shown in FIG. 5, to determine a second angle coarseness of the effect pigment where the second angle is at least 30 degrees different from the first angle.

It is most preferred that the first angle of viewing the paint and the coarseness gauge is between 30 degrees and 90 degrees with respect to the painted surface of the object. This first angle is known by those skilled in the art as a specular view, face-on view, or flash view. Ideally, the light source 24 illuminating the paint is in front of the user viewing the paint. Furthermore, it is most preferred that the second angle of viewing the paint and coarseness gauge is between 0 degrees and 30 degrees with respect to the painted surface. This second angle is known by those skilled in the art as a pitch view or flop view. Ideally, the light source 24 illuminating the paint is behind the user viewing the paint.

Referring to FIGS. 3-5, the coarseness gauge 20 also preferably defines at least one hole 26 such that the paint of the object may be viewed through the hole 26. More preferably, the coarseness gauge 20 defines five holes 26, with one hole 26 in each of the five discrete sections 22. By viewing the effect pigment of the object's paint through the holes 26, the effect pigment of the paint can be easily compared to the coarseness of each section of the coarseness gauge.

The method 100 of the first embodiment also includes the step 112 of selecting the paint formula from the list of paint formulas based on the coarseness of the effect pigment. More specifically, the best paint formula, i.e., the paint formula that provides the most accurate match, is selected from the list. This step is preferably performed by the computer 18. The computer 18 receives the coarseness observation(s) from the user and selects the paint formula accordingly. The apparent coarseness ratings associated with each formula may have been assigned by prior visual assessment or by mathematical prediction. A mathematical function is used to predict the particle size at both the face and flop views based on the paint recipe.

The method 100 may also include the step 114 of adjusting the paint formula based on the coarseness of the effect pigment. The same mathematical function describe above used to select the paint formula may also be used in adjusting the paint formula. An algorithm utilizes the function to modify the formula in small iterative steps. The adjustment process, i.e., the iterations, ceases once predicted particle size and color values closely match those specified by the user. Logic statements in the form of rules may additionally be used to aid the speed and accuracy of this adjustment algorithm.

The computer 18 may utilize one coarseness observation or multiple observations in the selection and/or adjustment steps 112, 114. Preferably, the computer 18 utilizes a neural network algorithm, i.e., an algorithm containing a neural network, to predict particle size ratings and color values in selection and adjustment of the paint formula. Neural networks for use in paint matching are known to those skilled in the art. Examples of such neural networks are disclosed in U.S. Pat. Nos. 6,714,924 and 6,804,390, both to McClanahan, which are hereby incorporated by reference. Other analytical functions may be used to predict the appearance properties, e.g., polynomial function. The adjustment algorithm may be based on steepest descent, non-linear optimization, genetic or other common models. Alternatively, other types of algorithms may also be used to perform the adjustment of the paint formula, including, but not limited to, scattering and absorbance models.

The computerized system 10 may also include a display 28 in communication with the computer 18. Furthermore, the method 100 may also include the step of communicating the modified paint formula such that paint may be mixed in accordance with the modified paint formula. The communication of the modified paint formula may be to the user via the display 28. Alternatively, a printer (not shown) could print the modified paint formula or the modified paint formula could be transmitted directly to a paint mixing apparatus (not shown).

The display 28 is preferably a color display 28 such that the color, texture, and/or sparkle of the paint formula may also be displayed on the color display 28. This allows the the displayed color to be compared to the painted object. Therefore, the paint formulation may be confirmed before the paint is mixed. The color display 28 may be integrated with a handheld device (not shown) for portability, i.e., able to be placed adjacent to the painted object.

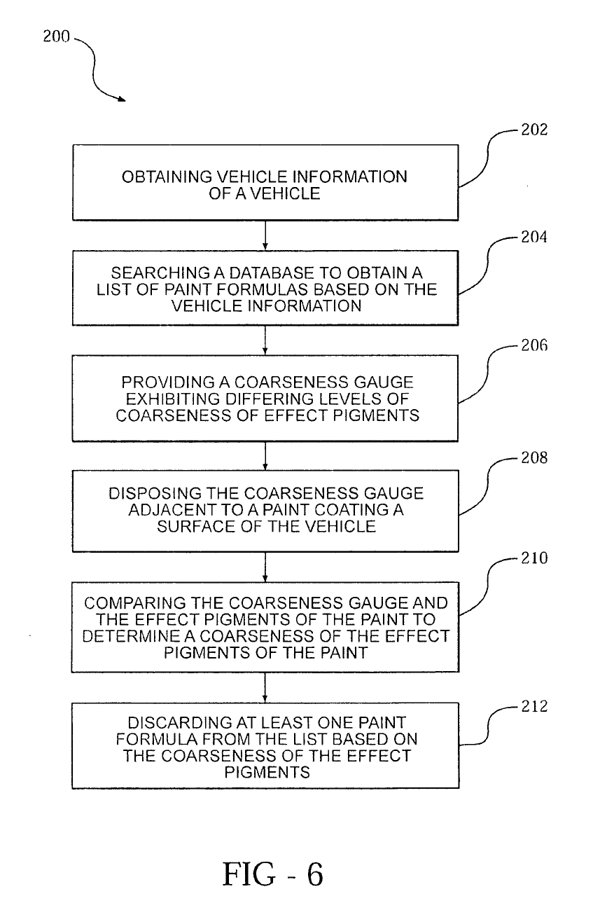

Referring now to FIG. 6, a second embodiment of the present invention provides the method 200 of determining a paint formula to match a paint coating a surface of a vehicle 14 utilizing a computerized system. The paint includes an effect pigment.

The method 200 includes the step 202 of obtaining vehicle information. This vehicle information is used to generally or specifically identify the vehicle 14, and thus, the paint coating the vehicle 14. For example, the vehicle information may be a vehicle identification number (VIN). Alternatively, the vehicle information may be the year, make, model, and general color of the vehicle 14. Those skilled in the art realize other types of vehicle information that may be used to identify the paint coating the vehicle 14.

This vehicle information is communicated to the computer 18. The method 200 further includes the step 204 of searching a database 30 to obtain a list of paint formulas based on the vehicle information. The database 30 is in communication with the computer 28. Preferably, the database 30 is disposed on a server 32 remote from the computer 18. As such, communication between the database 30 and the computer 18 is accomplished through a network 34, such as, but not limited to, the Internet. Alternatively, the database 30 may be disposed on the computer 18. Preferably, the list of paint formulas is stored on a memory of the computer 18.

The method 200 of the second embodiment also includes the step 206 of providing the coarseness gauge 20 exhibiting differing levels of coarseness of the effect pigment. This step 206 is similar to that of the first embodiment and the coarseness gauge 20 exhibits the same preferences as that of the first embodiment. Also similar to the first embodiment, the method 200 also preferably includes the step 208 of disposing the coarseness gauge adjacent to the coated surface of the vehicle.

The method 200 further includes the step 210 of comparing the coarseness gauge and the effect pigment of the paint to determine a coarseness of the effect pigment of the paint. As with the first embodiment, the step 210 of comparing the coarseness gauge and the effect pigment of the paint may be further defined as viewing the coarseness gauge and the paint at a first angle with respect to the surface to determine a first angle coarseness of the effect pigment and viewing the coarseness gauge and the paint at a second angle with respect to the surface to determine a second angle coarseness of the effect pigment. The second angle is preferably at least 30 degrees different from the first angle.

The method 200 of the second embodiment also includes the step 212 of discarding at least one paint formula from the list based on the coarseness of the effect pigment. Specifically, the discarded paint formula(s) are those that do not correlate with the observed coarseness of the effect pigment. Preferably, the discarding of the at least one paint formula is based on both the first angle coarseness and the second angle coarseness. The coarseness ratings associated with the paint formulations may be stored in the database housing the formulations. The ratings may have been assigned by visual examination by a skilled colorists or by calculation using algorithms to predict coarseness based on the composition of the formulation. It is also preferred that the neural network algorithm be applied to determine which paint formula or formulas to discard from the list. The paint formula(s) may be discarded from the list by removing them from the memory in which the list of paint formulas is stored. The decision as to which formula(s) to discard is based on logic and established tolerances.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. A method of determining a paint formula to match paint coating a surface of an object and including an effect pigment utilizing a computerized system, said method comprising:
measuring a color of the paint using a spectrophotometer;
determining a list of paint formulas based on the measured color;
providing a coarseness gauge exhibiting differing levels of coarseness of the effect pigment;
disposing the coarseness gauge adjacent to the coated surface of the object;
comparing the coarseness gauge and the effect pigment of the paint to determine a coarseness of the effect pigment of the paint;
selecting the paint formula from the list of paint formulas based on the coarseness of the effect pigment; and
communicating the paint formula such that paint may be mixed in accordance with the paint formula.

2. A method as set forth in claim 1 further comprising the step of adjusting the selected paint formula based on the coarseness of the effect pigment to produce a modified paint formula.

3. A method as set forth in claim 2 wherein said step of communicating the paint formula is further defined as communicating the modified paint formula such that paint may be mixed in accordance with the modified paint formula.

4. A method as set forth in claim 2 wherein said step of comparing the coarseness gauge and the effect pigment of the paint is further defined as the steps of viewing the coarseness gauge and the paint at a first angle with respect to the surface to determine a first angle coarseness of the effect pigment and viewing the coarseness gauge and the paint at a second angle with respect to the surface to determine a second angle coarseness of the effect pigment wherein the second angle is at least 30 degrees different from the first angle.

5. A method as set forth in claim 4 wherein said step of adjusting the paint formula based on the coarseness of the effect pigment is further defined as the step of adjusting the paint formula to produce an adjusted paint formula of the paint based on the first angle coarseness and the second angle coarseness.

6. A method as set forth in claim 4 wherein the first angle is between 30 degrees and 90 degrees with respect to the surface.

7. A method as set forth in claim 4 wherein the second angle is between 0 degrees and 45 degree with respect to the surface.

8. A method as set forth in claim 1 wherein the coarseness gauge is divided into a plurality of sections.

9. A method as set forth in claim 8 wherein the plurality of sections of the coarseness gauge is further defined as five sections.

10. A method as set forth in claim 2 wherein said step of adjusting the paint formula includes the step of applying at least one algorithm containing a neural network to produce the adjusted paint formula.

11. A method as set forth in claim 1 wherein the computerized system includes a color display and further comprising the step of displaying a color and appearance corresponding to the paint formula.

12. A method of determining a paint formula to match a paint coating a surface of a vehicle and including an effect pigment utilizing a computerized system, said method comprising:
obtaining vehicle information;
searching a database to obtain a list of paint formulas based on the vehicle information;
providing a coarseness gauge divided into a plurality of sections exhibiting differing levels of coarseness of the effect pigment;
disposing the coarseness gauge adjacent to the coated surface of the vehicle;
comparing the coarseness gauge and the effect pigment of the paint to determine a coarseness of the effect pigment of the paint;
discarding at least one paint formula from the list based on the coarseness of the effect pigment; and
communicating the modified paint formula such that paint may be mixed in accordance with the modified paint formula.

13. A method as set forth in claim 12 wherein said step of comparing the coarseness gauge and the effect pigment of the paint is further defined as the steps of viewing the coarseness gauge and the paint at a first angle with respect to the surface to determine a first angle coarseness of the effect pigment and viewing the coarseness gauge and the paint at a second angle with respect to the surface to determine a second angle coarseness of the effect pigment wherein the second angle is at least 30 degrees different from the first angle.

14. A method as set forth in claim 13 wherein said step of discarding at least one paint formula is further defined as the step of discarding at least one paint formula based on the first angle coarseness and the second angle coarseness.

15. A method as set forth in claim 12 wherein the first angle is between 30 degrees and 90 degrees with respect to the surface.

16. A method as set forth in claim 12 wherein the second angle is between 0 degrees and 45 degree with respect to the surface.

17. A method as set forth in claim 12 wherein the coarseness gauge is divided into a plurality of sections.

18. A method as set forth in claim 17 wherein the plurality of sections of the coarseness gauge is further defined as five sections.

19. A method as set forth in claim 12 wherein the step of discarding at least one paint formula includes the step of applying at least one algorithm containing a neural network to determine the at least one paint formula to discard from the list.

20. A method as set forth in claim 12 further comprising the step of applying at least one algorithm containing a neural network to predict color and appearance of at least one paint formula from the list of paint formulas.

21. A method as set forth in claim 12 wherein the computerized system includes a color display and further comprising the step of displaying a color and appearance corresponding to at least one of the paint formulas.

22. A computerized system for determining a paint formula of paint having an effect pigment and coating a surface of an object, said system comprising:
a spectrophotometer for measuring a color of the paint coating the object and producing color information;
a coarseness gauge exhibiting differing levels of coarseness of the effect pigment and wherein said coarseness gauge is movable adjacent to the surface of the object; and
a computer for receiving the color information and the coarseness, determining a list of paint formulas based on the color information, selecting the paint formula from the list of paint formulas based on the coarseness of the effect pigment, and communicating the paint formula such that paint may be mixed in accordance with the paint formula.

23. A system as set forth in claim 22 wherein said coarseness gauge defines at least one hole such that the paint of the object may be viewed through said hole.

24. A system as set forth in claim 22 further comprising a color display for displaying a color corresponding to the adjusted paint formula including the impact of the effect pigment.

25. A system as set forth in claim 22 wherein said computer also adjusts the selected paint formula based on the coarseness of the effect pigment by utilizing at least one algorithm containing neural networks.
